(19) United States
(12) Patent Application Publication
(10) Pub. No.: US 2013/0185129 A1
(43) Pub. Date: Jul. 18, 2013

(54) Methods and Systems of Payment for Automatic Generation of Discount Transactions

(71) Applicants: John F. Berman, Merion, PA (US); Benoit J. Meister, Brooklyn, NY (US); Mark Sandos, Villanova, PA (US); Catherine Root, Coatesville, PA (US)

(72) Inventors: John F. Berman, Merion, PA (US); Benoit J. Meister, Brooklyn, NY (US); Mark Sandos, Villanova, PA (US); Catherine Root, Coatesville, PA (US)

(21) Appl. No.: 13/350,133

(22) Filed: Jan. 13, 2012

(51) Int. Cl. G06Q 30/02

(52) U.S. Cl. 705/14.25; 705/14.1

(57) ABSTRACT

Due to increased competition in the financial services market for merchants, merchant acquiring banks, payment processors, and card-issuing banks, a method and system of payment for automatic generation of discount transactions is offered. Any actor in the purchasing process generates discounts automatically by receiving a purchase transaction dataset, comparing available discount datasets, and asynchronously generating a discount in a manner more accessible than coupons or reward cards.

### FIELD OF THE INVENTION

The present invention generally concerns payment solutions and commercial incentive mechanisms in the credit card, debit card, and personal check industries, incentivizing both a merchant's acceptance of a payment solution and a customer's preferential use of a payment solution in making purchases. More particularly, the invention concerns processes for automatic generation of discounts when using these methods of payment in purchase transactions.

### BACKGROUND OF THE INVENTION

In the past decades, there has been increased competition among institutions that provide and support payment solutions such as credit cards, debit cards, and personal checks. The type of providers has diversified from only banks to associations, consumer product merchants, and other third-parties. As a way of attracting more clients, institutions have created incentive programs that are associated with these methods of payment, with the goal of incentivizing use of their payment solutions over those of their competitors.

A type of credit card, often called a “reward card,” illustrates this trend. When using a reward card to pay for a purchase, a customer is rewarded for the use of the credit card by receiving pre-defined amounts of capitalization units, which include “points”, “miles,” or “rewards.” Amounts of these capitalization units are accumulated in a special account and traded later for pre-defined goods and services or, in some instances, for cash.

On the other hand, merchants that offer products and services for sale also are increasingly competitive in recent years, and offer lower and lower prices and more deals in order to entice customers to shop with them. The options available to merchants seeking to incentivize purchase through them include the offering of coupons and store-branded discount credit cards associated with a merchant that offer various perks in connection with their use (such as, for example, a Macy's® credit card that offers reward points useable only at Macy's® stores). However, one practical problem with these is that, in order to benefit from discounts from several merchants, a user has to subscribe to as many store-branded cards. Having to carry many cards is impractical. In addition, a user who would possess many store-branded credit cards would bear the burden of managing many bank accounts, which is undesirable.

As a matter of background, and in order to fully comprehend the scope of the disclosed invention, it is useful to understand the operation of methods of payment such as credit cards, debit cards, and personal checks(as well as associated methods of payment) as they are used in a purchase transaction. The purchase transaction begins by the customer paying for an order from a merchant using the method of payment. After scanning of the method of payment using the merchant's point of sale equipment, the merchant sends customer information (such as, for example, a customer's name, address, customer identification information, and the amount of purchase) to a payment gateway which, in turn, checks a payment gateway database to identify a merchant acquiring bank associated with the merchant. The merchant acquiring bank is an actor in a purchase transaction and a bank or financial institution the merchant has an agreement with to process its purchase transactions, and thereby accepts payments on behalf of the merchant.

After the merchant acquiring bank receives the customer's information, it is forwarded to a payment processor supporting the customer's method of payment, such as, for example, Visa, MasterCard, or American Express if the method of payment is a credit card. The payment processor is another actor in a purchase transaction. The payment processor also has an agreement or contract in place to act as a go between for the merchant acquiring bank and later actors in the purchase transaction.

The payment processor accesses a computer database to determine which payment issuing bank is associated with the customer information. Each method of payment is associated with a certain payment issuing bank that issues it, another actor in a purchase transaction, and having another agreement or contract to issue payment to other actors in the purchase transaction. Once the correct payment issuing bank is discovered by the payment processor, the customer information is further transmitted there. The payment issuing bank then executes a lookup regarding the customer information on its own computer database to determine whether there are enough funds present or not, whether the billing address with the customer information provided by the merchant matches the billing address in the file, and other pertinent information. Based upon this, if appropriate, an approval message is sent to the payment processor that forwards it to the merchant acquiring bank that again forwards it to the merchant to complete the transaction. Alternately, if the customer's information indicates that the transaction should not be allowed, a denial message is sent along the same path.

In practice, additional institutions may be receiving, processing and transmitting information on the way from the payment processor to the payment issuing bank, as well as on the way back from the payment issuing bank. However, these additional institutions are not particularly relevant to the present invention. For instance, when the method of payment is a credit card, often the credit card brand (as for instance VISA or MasterCard) receives data, processes it, and sends it to the credit payment issuing bank. Similarly, some of the intermediate roles in the transaction may, in practice, be assumed by a single institution.

The present invention offers the opportunity for automatic generation of discount transactions by any of the institutions in a purchase transaction with the goal of providing a stronger incentive to the user, while also allowing a large set of institutions to use the present invention as a promotional vehicle. Instantaneous and easy discounts generated automatically encourage the use of a method of payment. The customer benefits by not having to carry a large number of membership cards or clipping and carrying coupons while still receiving discounts.

The desire to increase the customer base and gain advantage over competitors offering a similar payment solution is not limited, however to the payment issuing bank. In an embodiment of the invention, the merchant benefits by receiving automatically generated discounts on fees owed to the payment issuing bank which encourages merchants to accept a certain method of payment. The merchant does not have to install special payment processing machines and data connections dedicated to a unique method of payment in order to utilize this embodiment of the invention, which greatly enhances membership. Even the market for payment processors has become more competitive and with a desire to increase market share discounts are offered when a payment processor's services are used. In effect, when customers make a payment at the merchant using a method of payment, the payment processor generates a discount transaction payment and sends it to the merchant acquiring bank. This serves to encourage merchants to promote the payment processor's own methods of payment.

Further facilitating membership in an embodiment of the invention is that the invention does not require an expensive permanent data link to the institution responsible for generation of discount transactions. Instead, in this embodiment the invention acts to supplement existing transaction processing systems. Goals are achieved via an asynchronous connection, whereby data regarding the sales transactions is not necessarily transmitted in real-time but rather at asynchronous intervals and a data set regarding discount transaction data is generated remotely and returned to the merchant.

Discount transactions are also generated automatically by multiple institutions in the credit card payment process, making it more attractive to make purchases with them.

An embodiment of the present invention is optimally used by the payment issuing bank, which issues discount transactions to incentivize use of its own payment solutions. The payment issuing bank is responsible for settling requests for payments made directly or indirectly by merchants, when the payment is made by a customer using the method of payment issued by the issuing bank. As such, the bank naturally receives all transaction data associated with the method of payment. Although the payment issuing bank optimally uses the present invention, any institution involved in the processing of transactions, such as the merchant itself, the merchant acquiring bank, or even the payment processor benefits from embodiments of the invention, incentivizing their own financial services over their competitors. The invention also is employed by another party or a “discount processing party,” outside the traditional payment processing method who has data containing the available discounts and who receives at some point in the processing pathway the transaction data. This discount processing party then compares the transaction data with the data representing available discounts and creates a discount data set which it sends to the payment issuing bank for transmission to the merchant acquiring bank. Optionally, this party can send the discount data set to the payment processor or directly to the merchant acquiring bank. In one embodiment of the invention, the discount data set is sent by this discount processing party after the payment issuing bank has sent payment for the amount of the transaction to the merchant acquiring bank. In such embodiment the merchant acquiring bank sends payment representing the amount of the discount back to the payment issuing bank. In another embodiment of the invention the discount processing party sends the discount data set to the payment issuing bank or payment processor prior to the payment issuing bank having sent payment for the transaction to the merchant acquiring bank whereupon the issuing bank sends to the merchant acquiring bank an amount representing the transaction amount minus the discount amount for that purchase.

Prior art exists in the realm of discount programs. In U.S. Pat. No. 5,056,019, Schultz et al. discloses an “Automated Purchase Reward Accounting System and Method” that requires customers to carry one bar-coded membership card per merchant. Since the number of merchants a customer frequents is typically high (in the order of dozens), it requires a customer to carry a large number of membership cards. Furthermore, modifications to a merchant's existing point of sale equipment are required to take advantage of this invention.

In U.S. Pat. No. 6,014,635 Harris et al. discloses a “System and Method for Providing a Discount Credit Transaction Network” that again requires modifications to existing point of sale devices to recognize authorizations for sales transactions from a payment issuing bank and authorizations for discounts from a discount credit network. This invention also requires modifications to the chain of transaction processing between a merchant acquiring bank and the payment issuing bank, both differing from the present invention.

In U.S. Pat. No. 5,689,100 Carrithers et al. discloses a “Debit Card System and Method for Implementing Incentive Award Program.” This invention differs from the present invention in that it discloses a reward system where capitalization units must be put into a separate account which must be used exclusively to buy products or services at certain merchants who accept such capitalization units. This separate account also makes bookkeeping more difficult.

In U.S. Pat. No. 6,292,786 Deaton et al. discloses a “Method and System for Generating Incentives Based on Substantially Real-Time Product Purchase Information.” This invention, unlike the present invention, requires merchants to install and maintain a connection between the taught system and each point-of-sale. It also requires modifying the chain of transaction processing between the merchant bank and the payment issuing bank.

In U.S. Pat. No. 6,601,761 Katis discloses a “Method and System for Co-Branding an Electronic Payment Platform such as an Electronic Wallet.” This invention, however, requires merchants (who are possibly in direct competition) to join a common incentive program. Another limitation is that the only way for the customer to redeem the dollar amount that corresponds to the incentives is through buying further products from merchants participating in the common incentive program. If incentives are paper coupons, customers might be required to buy certain products at certain times.

In U.S. Pat. No. 7,747,524 Brown discloses a “Method and System for Discount Debit Card.” In this invention, the front-end processing is performed the traditional way: with transaction information being transmitted from a merchant to a merchant's acquiring processor and to a discount plan provider system. However, two major aspects of back-end processing, where the settlement occurs, are different in Brown. First, back-end processing does not involve the merchant's acquiring processor. Second, responsibility for distributing fees is given to the discount plan provider system, as opposed to other parties. Furthermore, the acquiring processor of every merchant involved in the discount plan would need to implement the special mode of operation. As discussed earlier, this is a logistical impediment to the actual implementation of the taught invention, and hence a significant limitation.

While these units may be suitable for the particular purpose employed, or for general use, they would not be as suitable for the purposes of the present invention as disclosed here.

### SUMMARY OF THE INVENTION

The present invention provides methods and systems of payment for automatic generation of discount transactions. Automatic generation of discount transactions incentivizes the use of a certain method of payment or the services of an institution that provides payment services over a competitor. Rather than conventional coupons, discount cards, frequent flier miles, or other perks of limited value, which still involve substantial effort on the part of a customer to use, discounts are generated automatically and effortlessly. Customers prefer discount programs to reward programs (such as reward programs that accumulate points, miles, or rewards) because typical discounts offered by merchants represent a higher percentage of the purchased value than rewards. Thus, the discounts offered are a strong incentive to use a given method of payment over another, or use the products or services offered by a certain merchant, payment issuing bank, merchant acquiring bank, or payment processor over another.

It is an object of the invention to communicate purchase transaction data regarding a method of payment such as a credit card, debit card, or personal check when data transmission facilities are available, rather than always immediately when a transaction is processed, while still granting automatic discount transactions efficiently. Accordingly, an embodiment of the invention utilizes asynchronous communications where any combination of a merchant acquiring bank, a payment processor, and a credit payment issuing bank are not in constant data communication but instead communicate transaction data or discount data either immediately or at a later time. Thus, in this embodiment if a transaction is processed immediately but data transmission is not available at the time, the full amount of purchase is sent which is later discounted, in part. On the other hand, if data transmission facilities are available immediately the determination of whether there is an available discount on a purchase is made immediately and payment for the discounted transaction is also sent immediately. It is even possible that a subset of a group of purchase transactions have been completed whereas others are still pending.

It is a further object of the invention to generate discount transactions by matching data on processed transactions with data regarding available discounts. Accordingly, in an embodiment of the invention discount transactions are automatically generated by receiving purchase transaction data then executing a lookup on a computer database containing information on available discounts, which after computer matching the data on available discounts is returned asynchronously, either immediately or a at a later time then data transmission facilities are available.

It is a further object of the invention to allow a discount transaction to be sent either at the “front-end” of the transaction or during the “back-end” processing. Accordingly, in an embodiment of the invention as a result of the asynchrony when the method of payment offering a discount transaction is used in paying for a transaction the transmission and processing of the discount transaction happens either during the so-called “front-end” processing or during the “back-end” processing. In the “front-end” processing data representing a purchase transaction is compared to a data set representing available discounts in a database by one of the entities in the traditional processing system (e.g. a merchant acquiring bank, a payment processor, a payment issuing bank, etc.) or by a discount processing party to create a data set representing available discounts for that transaction prior to the payment issuing bank sending payment to the merchant acquiring bank. The data set representing available discounts is received by the payment issuing bank which then uses the data set representing available discounts to calculate the payment for the transaction owed to the merchant acquiring bank. Thus, the discount for the particular transaction is determined prior to payment to the merchant acquiring bank and the payment to the merchant acquiring bank is adjusted to take into account any discounts for the transaction. On the other hand, in the “back end” processing the data set representing a purchase transaction is asynchronously compared to data set representing available discounts in a database by one of the entities in the traditional processing system (e.g. the merchant acquiring bank, the payment processor, the payment issuing bank, etc.) or by a discount processing party to create a data set representing a discount for that transaction after the payment issuing bank has sent payment to the merchant acquiring bank. A discount amount is then determined and sent to the merchant acquiring bank which then sends to the payment issuing bank an amount representing the original price minus the discounted amount to the payment issuing bank.

It is another object of the invention to obviate the need for customers to carry multiple membership cards issued by individual merchants to participate in a discount program. Maintaining one membership card per merchant frequented by a customer is difficult and time consuming, especially when you consider the number of merchants that desire the customer to utilize their unique membership cards. Accordingly, an embodiment of the invention does not rely on membership cards in its generation of automatic discounts, but rather relies on customer information associated with a payment solution.

It is still a further object of the invention to not require further specialized point of sale equipment other than that typically used to process methods of payment. Accordingly, an embodiment of the invention does not use anything beyond standard customer transaction data transmitted during a purchase transaction, and therefore does not require specialized point of sale equipment other than the merchant's point of sale equipment.

It is a further object of the invention to avoid the necessity of customers carrying coupons with them where they shop. Accordingly in an embodiment of the invention, discounts with the present invention do not involve utilization of coupons. Instead, the invention determines which discounts are available, then issues discounts based upon these details. Paper coupons are not involved at all.

It is still a further object of the invention to offer instantaneous return of capitalization units. Prior-art discount systems place capitalization units in a separate account which must later be used at pre-defined merchants and further these accounts require maintenance by the customer of a separate account. Accordingly, an embodiment of the present invention simplifies this process and offers instantaneous discounts on goods or services purchased.

It is still a further object of the invention to create a method for plan participants to dictate their own discount terms and conditions in an embodiment of the invention. Accordingly, in an embodiment of the invention an internet menu system is available for plan participants to access and define their own available discounts, which are later accessed and matched automatically. Discount terms and conditions are established by the plan participants, including the necessity to purchase a certain amount of goods or services, granting a discount only at certain times, demanding that a certain amount of goods or services are sold before discounts begin to issue, or otherwise.

It is still a further object of the invention to generate data sets representing purchase transactions automatically and then provide them to merchants via merchant acquiring banks. Accordingly, in an embodiment of the invention data representing available discounts is formed based upon a subset of data representing purchase transactions, and this information is sent by the issuing bank to the merchant acquiring bank for use in promoting sales and in other ways.

It is still a further object of the invention to increase and incentivize impulse buying by messaging customers in real-time as they are shopping to encourage them to buy more. Accordingly, in an embodiment of the invention purchases are tracked in real-time and compared with available discounts which are then forwarded to customers also in real-time via e-mail, SMS, Facebook®, or some other means. Being offered a sale while shopping capitalizes on human nature, demanding something be purchased only because it is less expensive at that time.

It is still a further object of the invention to increase and incentivize impulse buying by messaging customers when they are near to being eligible for a discount or further discount. This includes, for example, when the customer's amount of purchases at a merchant is near a level of purchase amount that would entitle the customer to a discount or further discount if the level of purchase is reached. Accordingly, in an embodiment of the invention purchases are tracked and compared with available discounts which are then forwarded to customers via e-mail, SMS, Facebook®, or some other means. Knowing that they are within reach of being entitled to a discount or additional discount at a particular merchant also capitalizes on human nature, incentivizing additional purchases because it will entitle the customer to a discount or additional discounts.

It is yet a further object of the invention to more strongly incentivize impulse buying. Accordingly, in an embodiment of the invention no pre-planning is necessary before discounts are received (pre-planning could include, for example, clipping coupons before shopping).

It is yet a further object of the invention to be able to ascertain which discount transactions are most useful and which the least in attracting customers while tracking locations where sales are made. Accordingly, in an embodiment of the invention, data representing issued discounts is stored and used in generating further discounts, along with data regarding locations of sales to customers.

One efficient way to determine such location is to obtain the location of each merchant and then to deduce the location of the sale from the identification of the merchant that is available on documents and data generated during the transaction. However, other ways to determine the location of the sale are acceptable as well. This information is later used in generating data representing available discounts or in other business research.

To the accomplishment of the above and related objects, the invention may be embodied in the form illustrated in the accompanying drawings. Attention is called to the fact, however, that the drawings are illustrative only. Variations are contemplated as being part of the invention, limited only by the scope of the claims.

### BRIEF DESCRIPTION OF THE DRAWINGS

In the drawings, like elements are depicted by like reference numerals. Various embodiments of the present invention are illustrated by way of example, and not by way of limitation, in the figures of the accompanying diagrams. The drawings are briefly described as follows:

FIG. 1 is a flowchart illustrating the operational flow of a method of payment and process for automatic generation of discounts in an embodiment of the invention.

FIG. 2 is a flowchart illustrating the operational flow of a further embodiment of the invention displaying a method of payment and process for automatic generation of discounts.

FIG. 3 is a flowchart illustrating a process of matching of purchase transactions with available discounts in an embodiment of the invention.

FIGS. 4A and 4B are together a flowchart displaying the operational flow of selecting admissible discounts based upon certain criteria in an embodiment of the invention.

FIGS. 5A and 5B illustrate another flowchart displaying the process of generation of a message discussing the discount transactions in an embodiment of the invention.

FIG. 6 is a flowchart illustrating the process of generating discount transactions in an embodiment of the invention.

### DETAILED DESCRIPTION OF THE PREFERRED EMBODIMENTS

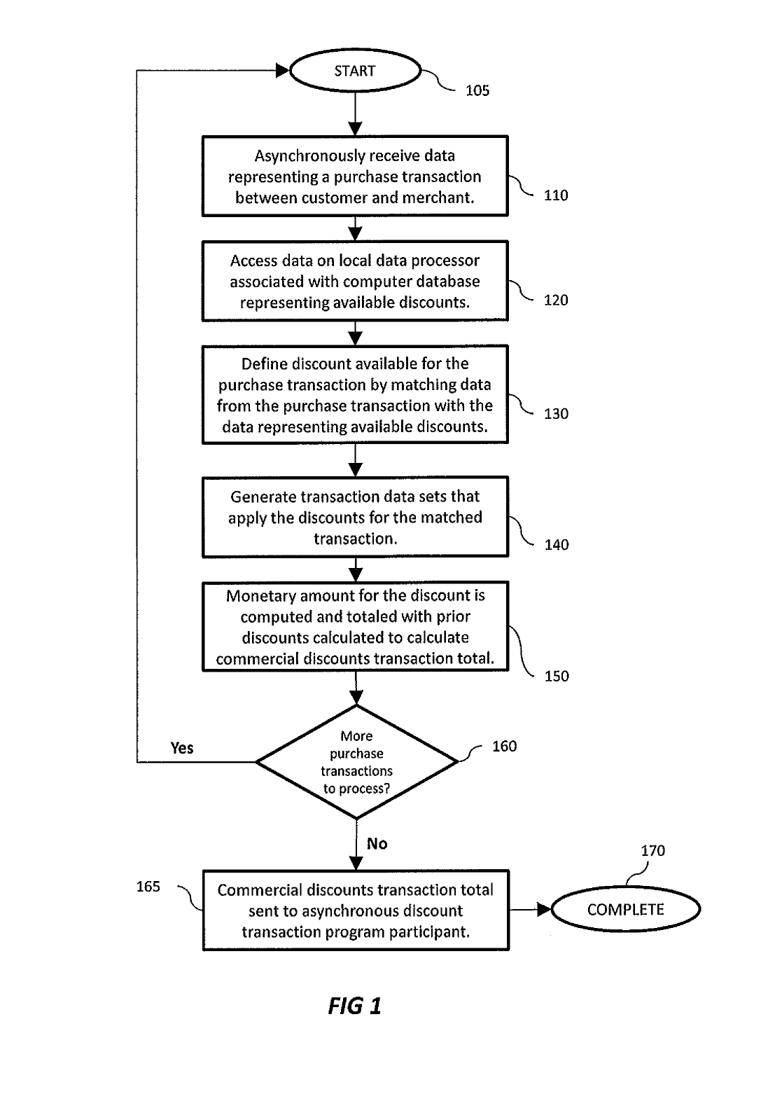

FIG. 1 is a flowchart illustrating the operational flow of a process for automatic generation of discounts in an embodiment of the invention executing on a local data processor associated with a computer database. Flow begins in block 105. At 110, data representing a purchase transaction between a merchant and a customer (paid for with a method of payment such as a credit card, debit card, personal check, or associated method of payment) is received asynchronously. The purchase transaction may or may not have already completed, and therefore data is received “asynchronously” to the purchase transaction itself 110. The data representing a purchase transaction may include (but is not limited to) identification of merchant, identification of customer, credit card number, amount of purchase and location of purchase. Flow continues to block 120, where data representing available discounts on the computer database are accessed by the local data processor. Flow continues in block 130, where the data representing the purchase transaction is matched with the data representing the available discounts to define a set of discounts on the purchase transaction. If there are conditions precedent to the receipt of the available discount, they are analyzed at step 130 by the local data processor's logic circuits. Examples of conditions include a condition that the purchase transaction is issued after a prescribed start date and time and before a prescribed end date and time, or a condition that the purchase transaction must be valued under or over a certain dollar value. Flow of the provided embodiment continues again in block 140, where a transaction data set is generated in-part from the data resulting from the set of discounts matched with the purchase transaction in block 130.

The transaction data set generated at step 140 may include, but is not limited to data identifying the merchant, data identifying the customer, the amount of the discount, and data allowing the merchant to check the validity of the discount. The generated data set is then sent directly or indirectly to the merchant's acquiring bank, initiating a new transaction. Actual encodings for the transaction data are obvious to one of skill in the art.

At 150 a monetary amount for the discount is computed and totaled with monetary amounts for prior discounts and a data set representing the transaction that applied the discount is generated.

The form taken by a payment the discount transaction in block 140 is obvious to the skilled in the art. At present, we believe that one good form for the transaction data generated in block 140 is in the form of an ACH transfer, for its low, fixed cost. The typical cost for an ACH transfer is in the order of half a cent. However, other forms are also satisfactory. ACH transfer stands for “Automatic Clearinghouse” or “Automatic Check Handling” transfer. ACH transfers are a standard protocol for transferring money from one bank to another.

Execution continues through the decision at step 160 and back to start 105 if there are more transactions to process. Otherwise, execution completes 170.

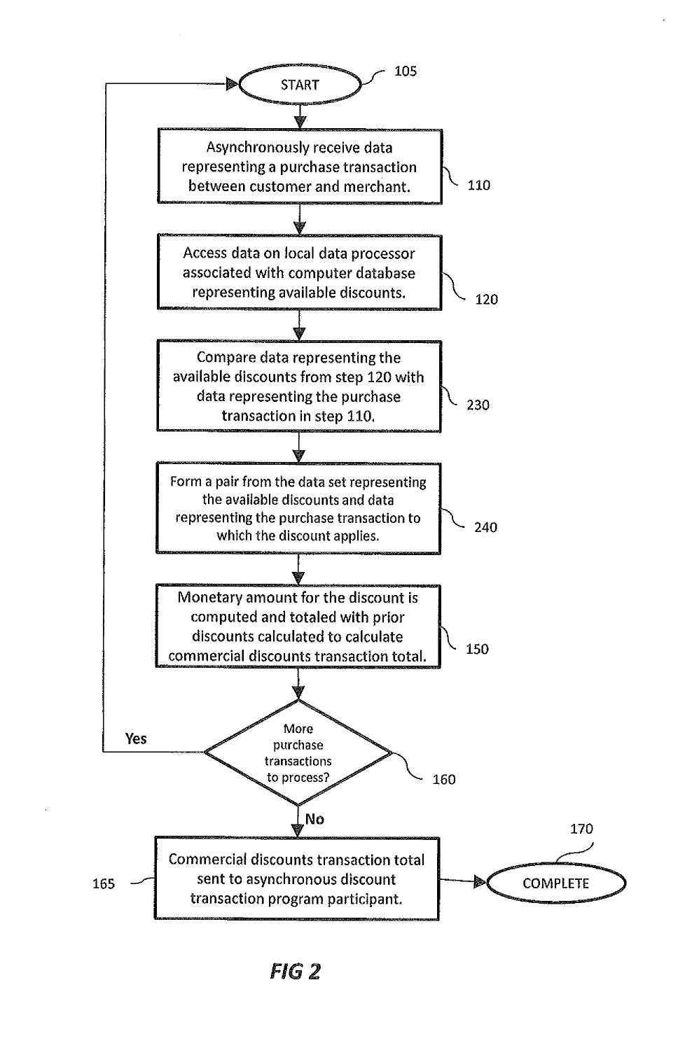

FIG. 2 represents flow of another process for generating a commercial discount transaction in a further embodiment of the present invention. Flow begins again in block 105. Data representing a purchase transaction between a customer and a merchant is received at step 110. Data representing available discounts is accessed on a local data processor associated with a computer database 120. At step 230 data representing available discounts (previously accessed at step 120) is compared to data representing the purchase transaction (previously received asynchronously at step 110). A pair is then formed from the data set representing available discounts and data representing the purchase transaction 240. The monetary amount for this discount is then computed and totaled with prior calculated discounts 150. If there are more transactions to process, execution of the program proceeds from step 160 back to step 105. Otherwise execution goes to step 165 where a commercial discounts transaction total is sent to asynchronous discount transaction program participant 165, then termination ends 170.

Mechanisms for performing the matching process of FIG. 2, step 240 are obvious to one of skill in the art. Typical implementations use a computer database managed by a structured query language like SQL. SQL provides structured queries formulated in the SQL language, or one of its existing extensions, to facilitate easy, efficient, and economical returns of requested data from the database. Examples of brand names for database systems that support SQL and its extensions include, but are not limited to, Oracle, PostgreSQL, and MySQL. However, other ways of forming a pair as required in step 240 are also satisfactory, such as hash functions. Hash functions are mappings that take a dataset and produce a simple index, allowing efficient comparison and matching of data sets.

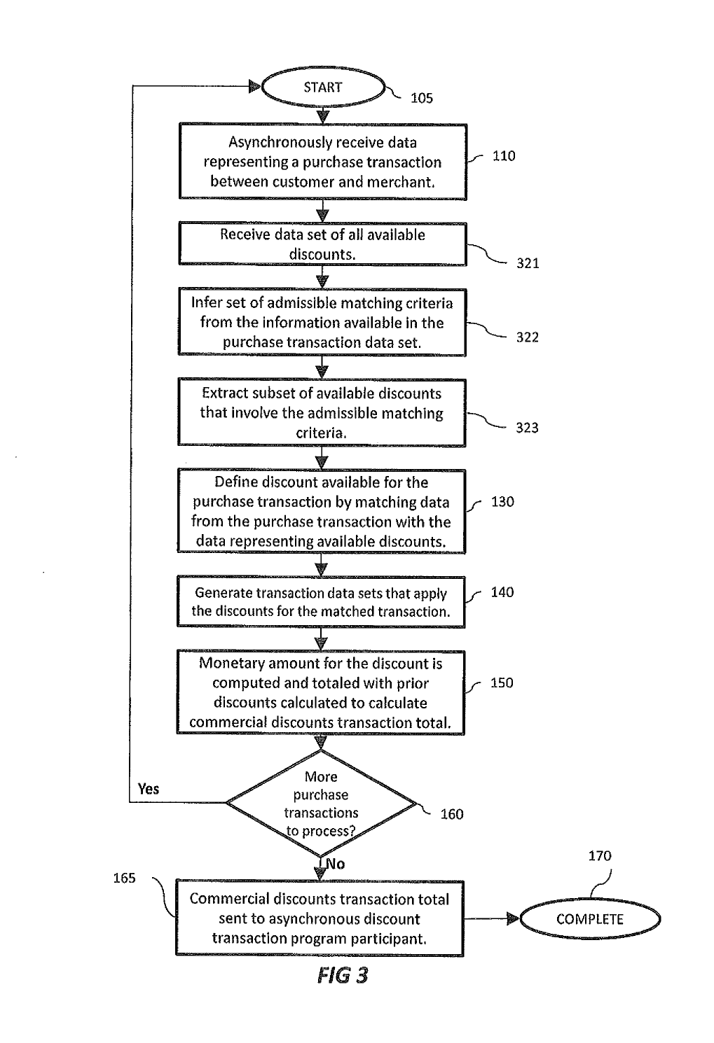

FIG. 3 represents a flow of another process for generating a commercial discount transaction in yet another embodiment of the present invention. Flow begins at step 105. The invention asynchronously receives data representing a purchase transaction between customer and merchant 110. In this embodiment a data set of all available discounts is received as well 321. A set of admissible matching criteria is inferred from the information available in the purchase transaction data set 322. A subset of available discounts that involve the admissible matching criteria is extracted 323 from the whole data set of available discounts. After step 323 and from step 130 and beyond, execution of FIG. 3 continues as with FIG. 1.

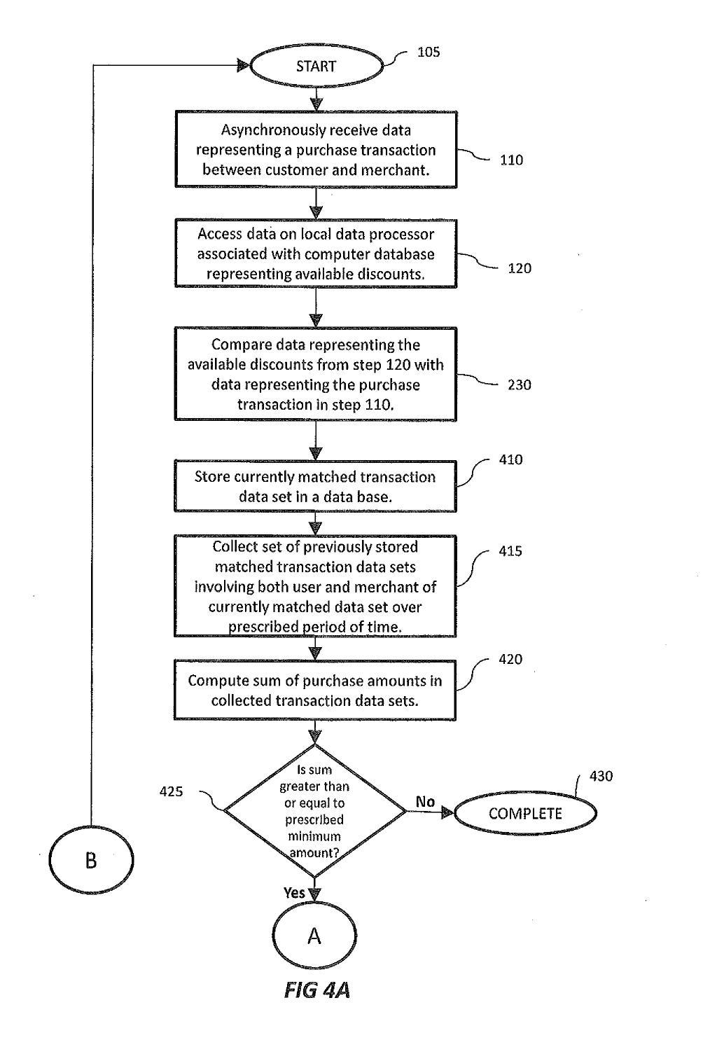

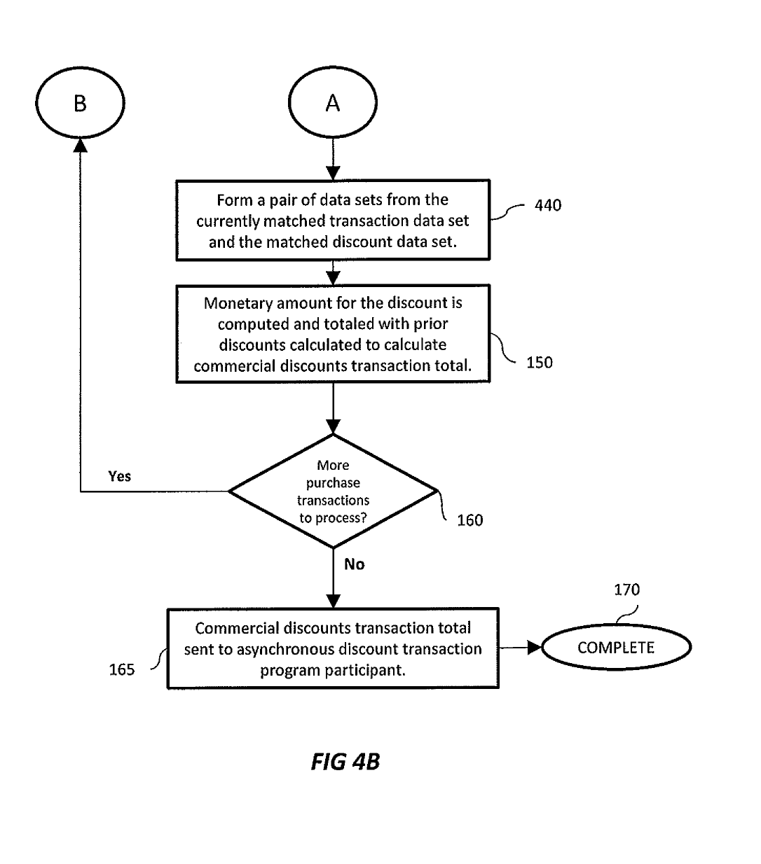

In a further embodiment displayed as FIGS. 4A and 4B, flow begins at step 105. Data representing a purchase transaction between a customer and a merchant is received asynchronously in step 110. Data representing available discounts is accessed on a local data processor associated with a computer database 120. At step 230 data representing the available discounts from step 120 is compared with data representing the purchase transaction from step 110. Currently matched transaction data is stored in a database 410. A set of previously stored matched transaction data sets involving both user and merchant of currently matched data set within a prescribed period of time are collected 415. A sum of purchase amounts in collected transaction data sets is computed 420. At step 425 a decision must be made whether the sum of purchase amounts is greater than a prescribed minimum purchase amount that the customer must have spent in purchases from the merchant within a prescribed period of time. If yes, execution continues in FIG. 4B, otherwise execution completes 430. In FIG. 4B, a pair of data sets from the currently matched transaction data set and the matched discount data set is formed 440. A monetary amount for a discount is computed and totaled with prior discounts calculated 150. If there are more purchase transactions to process execution returns to start 105 in FIG. 4A. Otherwise, a commercial discounts transaction total is sent to an asynchronous discount transaction program participant 165. Execution is now complete 170.

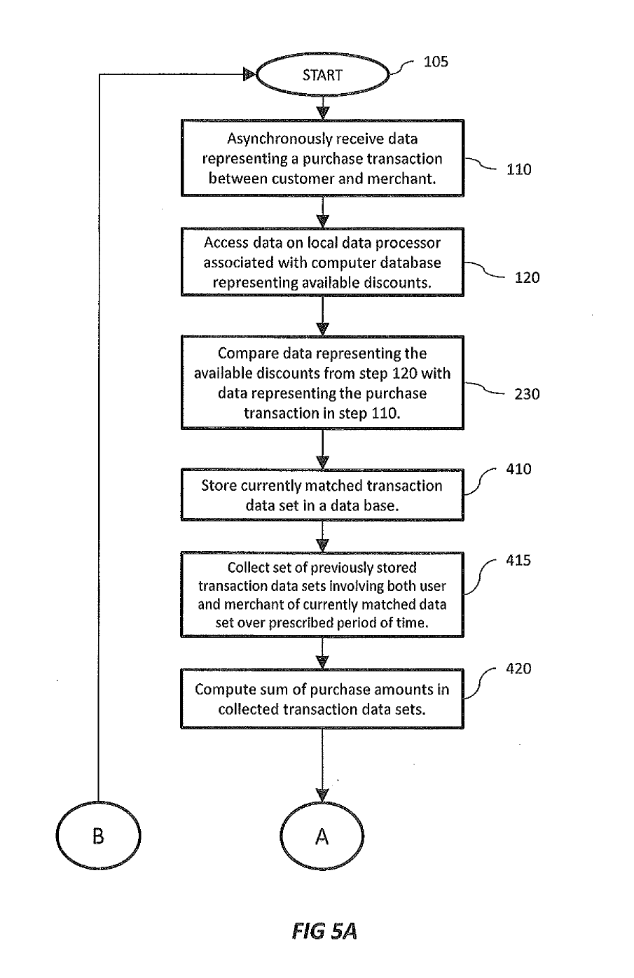

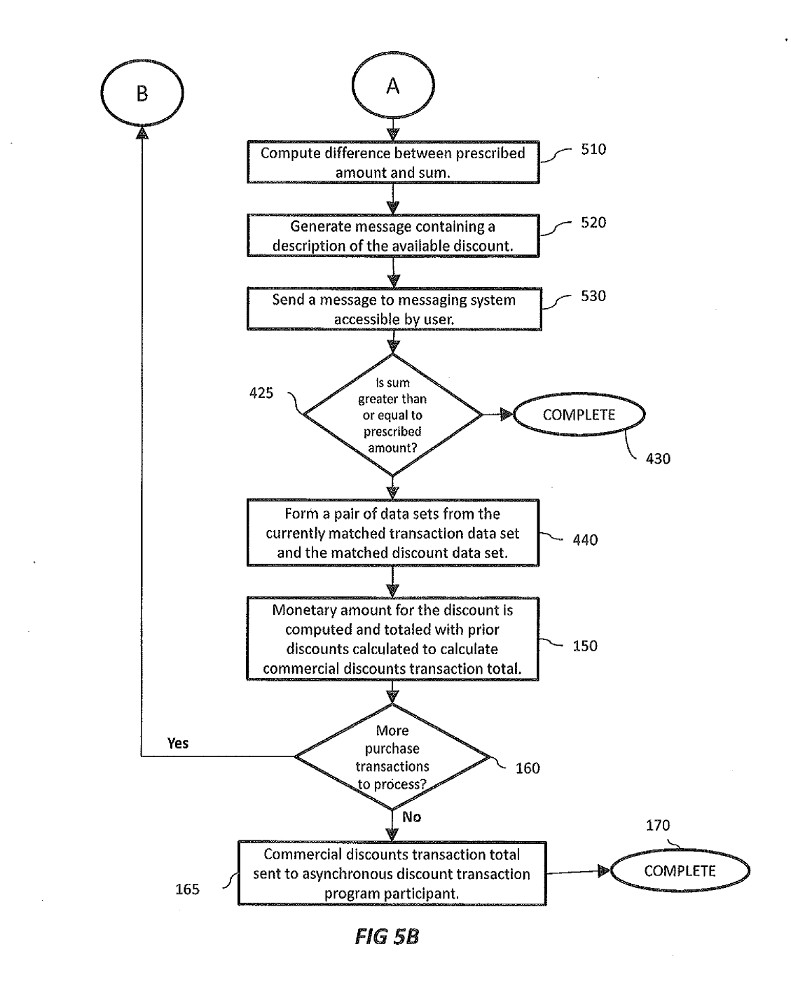

FIGS. 5A and 5B display another embodiment of the invention. Flow starts at step 105. Execution is as before with FIGS. 4A and 4B until step 510 on FIG. 5B. At step 510 a value for the difference between the prescribed amount and sum is calculated. In this embodiment a message is generated containing a description of the matched discount 520. The message is then sent via a messaging system accessible by the user. The contents of the message may include, but are not limited to, text identifying the merchant, the amount associated with the discount, the period of time for the discount and the computed difference, or other items. However, contents containing more or less information are also satisfying. Exemplars of such a messaging system are well known to the skilled in the art. The messaging systems include but are not limited to e-mail servers, webmail, web-based messaging, Short Message Service (SMS), fax, and integrated messaging systems such as available through Facebook, Google+, and the like. Other messaging systems are also appropriate. At steps 425 and beyond, execution of this embodiment continues as with FIG. 4B.

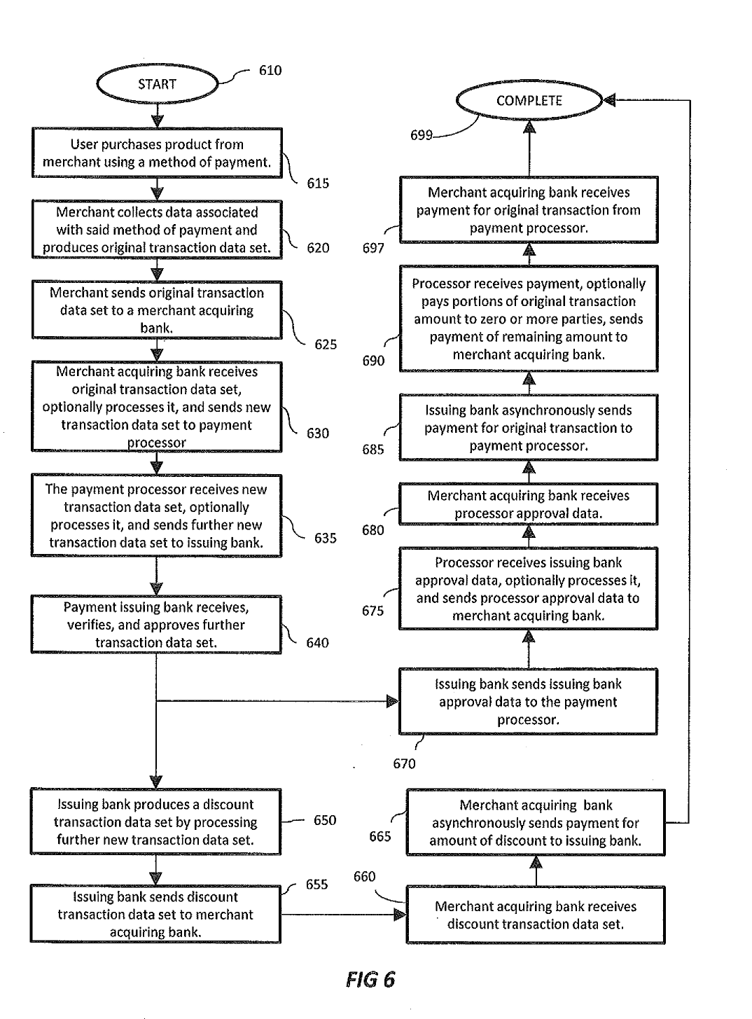

FIG. 6 represents the flow of another embodiment of the present invention. In this embodiment execution commences at step 610 and a customer purchases a product from a merchant using a method of payment in step 615. The merchant then collects information associated with the method of payment in step 620, and produces an original transaction data set. The information associated with the original transaction data set includes but is not limited to the item purchased, the amount paid, the name of the customer, the date of the transaction, and the location of the transaction. The flow continues in step 625, where the original transaction data set is sent to a merchant acquiring bank associated with the merchant. This bank may be either the merchant acquiring bank, or another bank serving as merchant acquiring bank for the purposes of processing the merchant acquiring bank's financial transactions. The flow then continues in step 630, where the merchant acquiring bank receives the original transaction data set from the merchant, processes it, if required, and sends a new transaction data set to a payment processor for the method of payment. The payment processor for the method payment is a bank or similar institution responsible for processing and dispatching transactions. In this embodiment, the flow continues in step 635, where the payment processor receives the new transaction data set from the merchant acquiring bank, processes it if required, and sends a further new transaction data set to the payment issuing bank. The further new transaction data set is received by the payment issuing bank in step 640, where it is verified and approved. Flow continues to step 640, where execution continues simultaneously to steps 650 (where the payment issuing bank produces a discount transaction data set by processing further new transaction data set) and 670 (where the issuing bank sends approval data to the payment processor). These steps and those following indicate the asynchrony of the execution of this embodiment of the invention as two paths proceed simultaneously. The flow proceeds from step 650 to 655 where the issuing bank sends the discount transaction data set to the merchant acquiring bank. At 660 the merchant acquiring bank receives the discount transaction data set. The merchant acquiring bank asynchronously sends payment for the amount of discount to the issuing bank 665. While steps 650 through 665 are proceeding, the issuing bank sends approval data to the payment processor 670. The payment processor then receives issuing bank approval data, processes it if required, and sends processor approval data to merchant acquiring bank 675. The merchant acquiring bank receives processor approval data 680.

At step 685 the issuing bank asynchronously sends payment for original transaction to the payment processor. The payment processor then receives payment, optionally pays portion of original transaction amount to zero or more parties, and sends payment of remaining amount to merchant acquiring bank 690. At step 697, the merchant acquiring bank receives payment for the original transaction from payment processor. From both steps 697 and 665 execution of the simultaneous paths completes 699.

What is claimed is:

1. A method of payment and process of operating a general purpose data processor of known type to enable said data processor to process input data and generate data representing commercial discount transactions from purchase transactions that are initiated using said method of payment, the process comprising:
asynchronously receiving data representing purchase transactions previously initiated between the user of the method of payment and at least one merchant using the method of payment;
receiving data representing discounts available to the user from merchants on their goods and services;
determining discounts available for said purchase transactions initiated between the user and the merchant, by matching said data representing the purchase transactions with said data representing the available discounts from the at least one merchant;
generating data representing transactions that apply the discounts found during the matching process; and
repeating the above process until all discounts applicable to the user's purchase transactions are applied;

2. The method of payment and process of claim 1, wherein the reception of data representing purchase transactions between the user and the at least one merchant is also followed
by the generation of data representing the transfer of reward points to an account in which reward points are assigned to the user of the method of payment;

3. The method of payment and process of claim 1, wherein the receiving of data representing discounts includes:
comparing the transaction data with available discount data; and
defining a pair for each successful match, the pair being formed from one data set representing the matched discount and from one data set representing the compared transactions to which the discount applies;

4. The method of payment and process of claim 3, wherein the definition of available discounts includes the condition that purchases from the merchant by the user have reached a prescribed amount within a prescribed period of time, and wherein:
the currently received transaction data set is stored in a data base;
the set of previously stored transaction data sets involving both the user and the merchant defined by the currently received transaction and received over the prescribed period of time is collected from the data base;
the sum of the purchase amounts defined by the collected transaction data sets is computed;
the sum is compared with the prescribed amount, and a pair defining a successful match is created from the currently received transaction data set and the matched discount data set if the sum is equal to or greater than the prescribed amount.

5. The method of payment and process of claim 4, wherein the comparison of the sum with the prescribed amount includes:
computing the difference between the prescribed amount and the sum;
generating a message that contains a description of the available discount, including data identifying the merchant, the prescribed amount, the prescribed period of time and the computed difference; and
sending the message to a messaging system from which the user can read the message.

6. The method of payment and process of claim 1, wherein the receiving of discount data includes:
receiving a broad set of data representing available discounts;
inferring a set of admissible matching criteria from the type of information present in the transaction data sets; and
extracting the subset of discount data sets that involve the admissible matching criteria from the broad set of data representing available discounts.

7. A method of payment and process of generating discount transaction, comprising:
receiving transaction data set indirectly from a merchant acquiring bank representing data from a transaction between a customer using the method of payment and a merchant;
producing a discount transaction data set upon receiving the transaction data set by processing the transaction data set;
sending said discount transaction data set to the merchant acquiring bank, the discount data set including data identifying the original transaction;
asynchronously receiving payment for the amount of the discount transaction from the merchant acquiring bank.

8. The method of payment and process of claim 7, wherein the discount transaction set is produced by processing the transaction data set using the method and process of claim 1.

9. The method of payment and process of claim 7, wherein the payment of the amount of the discount transaction is performed using an ACH transfer.

10. The method of payment and process of claim 7 wherein:
upon receiving the new transaction data set, the payment processor produces a discount transaction data set by processing said new transaction data set;
the payment processor sends said discount transaction data set to the merchant acquiring bank, the discount transaction data set including data identifying the original transaction;
the merchant acquiring bank receives the discount transaction data set;
the merchant acquiring bank asynchronously sends payment for the amount of the discount transaction to the payment processor; and
the payment processor receives the payment and sends a payment for the amount of the discount transaction to the issuing bank;
the issuing bank receives the payment for the amount of the discount transaction.

11. The method of payment and process of claim 1, wherein the data representing available discounts is stored in a data base, and in which
a merchant compiles a data set describing a current or future available discount;
the merchant sends the data set to a verification system;
the verification system receives the data set and verifies the validity of the received data set; and
the verification system formats the data set and writes the formatted data set to the data base representing the available discounts.

12. A method of generating discount transactions from purchase transactions that are initiated using said method of payment, the method comprising:
receiving data representing purchase transactions previously initiated between the user of the method of payment and at least one merchant using the method of payment;
generating a new transaction dataset;
sending the new transaction data for the purchase transactions by indirect transmission to a payment issuing bank associated with the method of payment;
receiving approval or denial for the original amount of purchase in the purchase transaction dataset from the payment issuing bank;
receiving a data discount set from the issuing bank representing discounts available to the user from merchants on their goods and services on all or part of the original transaction determined by matching said data representing the purchase transactions with said data representing the available discounts from the at least one merchant;
receiving asynchronously a payment for the purchase transaction, said payment for the purchase transaction calculated by subtracting the amount of a discount transaction value generated by the payment issuing bank from the original amount of purchase.

13. The method of generating conditions in order to receive custom discounts comprising:
an internet menu system available for plan participants to access and define the available discounts for holders of the payment methods.

14. The method of payment of claim 7, wherein the producing a discount data set includes:
comparing the transaction data with available discount data.

15. A method of payment and process of generating discount transaction, comprising:
receiving transaction data set indirectly from a merchant acquiring bank representing data from a transaction between a customer using the method of payment and a merchant;
producing a discount transaction data set upon receiving the transaction data set by processing the transaction data set;
sending said discount transaction data set to the merchant acquiring bank;
sending payment to the merchant acquiring bank in an amount representing the amount of the transaction minus an amount representing the discount for that transaction.

16. The method of payment of claim 16, wherein the producing a discount data set includes:
comparing the transaction data with available discount data.
